(19) United States
(12) Patent Application Publication
(10) Pub. No.: US 2026/0243919 A1
(43) Pub. Date: Aug. 20, 2026

(54) METHOD AND APPARATUS FOR TESTING GEOLOGICAL ACTIONS, MEASURING TAKEN GEOLOGICAL ACTIONS, AND CALIBRATING GEOLOGICAL PROBABLISTIC MODELS

(71) Applicant: Terra AI, Inc., Redwood City, CA (US)

(72) Inventors: John Michael MERN, San Jose, CA (US); Anthony Louis CORSO, San Francisco, CA (US)

(21) Appl. No.: 19/541,911

(22) Filed: Feb. 17, 2026

Related U.S. Application Data
(60) Provisional application No. 63/760,053, filed on Feb. 18, 2025.

(51) Int. Cl. G01V 20/00

(52) U.S. Cl. CPC G01V 20/00

(57) ABSTRACT

In an embodiment, a method includes receiving a first geological model associated with a geological site. The method further includes determining a first recommended action, where the first recommended action is for a first stage of a subsurface resource exploration process. The method further includes receiving an indication representing a first result resulting from taking the first recommended action at the geological site. The method further includes updating the first geological model based on the first result to generate a second geological model. The method further includes determining a second recommended action based on a project objective and the second geological model, where the second recommended action is for a second stage of the subsurface resource exploration process.

### CROSS REFERENCE TO RELATED APPLICATIONS

This application claims priority to and the benefit of U.S. Patent Application No. 63/760,053, filed Feb. 18, 2025, and titled METHOD AND APPARATUS FOR TESTING GEOLOGICAL ACTIONS, MEASURING TAKEN GEOLOGICAL ACTIONS, AND CALIBRATING GEOLOGICAL PROBABILISTIC MODELS, which is hereby incorporated by reference in its entirety.

### FIELD

One or more embodiments are related to testing geological actions, measuring taken geological actions, and calibrating geological probabilistic models.

### BACKGROUND

Some known techniques for determining actions to take during subsurface resource exploration are inaccurate and computationally expensive and/or burdensome. According, techniques that determine actions to take during subsurface resource exploration that are more accurate and less computationally expensive and/or burdensome can be desirable.

### SUMMARY

In an embodiment, a method includes receiving a first geological model associated with a geological site. The method further includes determining a first recommended action, where the first recommended action is for a first stage of a subsurface resource exploration process. The determining the first recommended action includes determining a first action based on a project objective and the first geological model, simulating the first action using the first geological model to generate a first simulated output, updating the first geological model based on the first simulated output to generate a second geological model, determining a second action based on the project objective and the second geological model, simulating the second action using the second geological model to generate a second simulated output, updating the second geological model based on the second simulated output to generate a third geological model, and determining the first recommended action based on the project objective and the third geological model. The method further includes receiving an indication representing a first result resulting from taking the first recommended action at the geological site. The method further includes updating the first geological model based on the first result to generate a fourth geological model. The method further includes determining a second recommended action based on the project objective and the fourth geological model, where the second recommended action is for a second stage of the subsurface resource exploration process.

### BRIEF DESCRIPTION OF THE DRAWINGS

FIG. 1 illustrates a system block diagram to repeatedly generate recommended actions and update geological models based on actions taken in response to the recommended actions, according to an embodiment.

FIG. 2 illustrates a nested loop flow process to repeatedly update geological models based on potential actions and results of recommended action, according to an embodiment.

FIG. 3 illustrates a flow process to take and measure actions, according to an embodiment.

FIGS. 4A and 4B illustrate a flowchart of a method to determine recommended actions for stages of a subsurface resource exploration process, according to an embodiment.

FIG. 5 illustrates a flow process to consider various combinations of potential actions at a stage of a subsurface exploration process, according to an embodiment.

FIG. 6 illustrates a flowchart of a method 600 to determine recommended actions for stages of a subsurface resource exploration process, according to an embodiment.

### DETAILED DESCRIPTION

In some implementations, a "geological model" refers to a digital representation of a subsurface (e.g., Earth's subsurface) that integrates geological, geophysical, and/or geochemical data to visualize and analyze the arrangement of geological features.

In some implementations, a "probabilistic geological model" refers to a geological model that incorporates uncertainty into the depiction of subsurface conditions. A probabilistic geological model can consider multiple possible scenarios based on varying data and assumptions and can generate a range of possible outcomes (e.g., in the form of probability distributions), reflecting the uncertainty inherent in geological data, measurement errors, and/or variability in subsurface conditions.

A goal of subsurface resource exploration can be to locate a resource (e.g., an ore deposit) and then measure the size, quality, and other parameters of the resource such that an extraction plan can be designed (e.g., a mine or reservoir well pattern). For some known techniques, however, decisions about where and what data to collect in exploration are largely qualitative and heuristic. For example, a geologist may interpret a map of the strength of a geophysical signal and decide where to drill based on analogies to prior discoveries. Some quantitative methods have been proposed for specific segments of the exploration process. For example, early drilling trajectories can be designed to increase the intersection with an anomalous body based on a three-dimensional (3D) model. These known methods, however, are limited in scope and effectiveness. Other known methods have proposed information theory as an approach, but such known methods are rarely used because of uncertainty regarding how increasing information theoretic measures (e.g., entropy) will benefit the economics of an exploration project.

Some implementations use a different paradigm from information theory to capture how any potential action (e.g., measurement) will impact downstream subsurface resource exploration project success and/or outcomes. In some implementations, a closed-loop optimization system simulates how potential actions will impact future outcomes as part of a multi-step sequence. The expected impact that a measurement (sometimes referred to herein as "action") will have on the results of a subsurface resource exploration project can be directly measured. Some implementations consider the particular constraints, objectives, and other logistical considerations of a given project to predict outcomes and recommend actions.

Some implementations improve (e.g., optimize) a closed-loop decision making process in which new and/or additional information is repeatedly (e.g., continually, periodically, sporadically, etc.) used to update world models (also referred to herein as "geological models") and refine future decisions. This process can be represented using an outer loop, in which a data filter updates a probabilistic world model (also referred to herein as "probabilistic geological model") (e.g., an ensemble) using new data acquired from measurements. To improve (e.g., optimize) this outer loop, some implementations can replicate the full closed-loop sequence of decisions in simulation in an inner loop. In the inner loop, an action planner algorithm selects a candidate action (also referred to herein as "potential action") to simulate at each step in a given sequence. This candidate action can be simulated using, for example, a neural surrogate model and the resulting signal is used by a data filter to update the probabilistic geological model. This process can repeat for each step / stage in a simulated project sequence (e.g., subsurface resource exploration process) and (optionally) a quantitative score can be calculated for each sequence according to a provided objective/reward function. In some implementations, thousands to millions of projects are simulated for each decision. At completion of the simulations, the candidate action with, for example, the best and/or most desirable expected performance, estimated from the aggregated simulations, is recommended. In some implementations, in response to recommending an action, the action is taken. For example, the action can be taken by a human. Additionally or alternatively, as another example, the action can be taken by a compute device, robot, equipment, and/or the like. In some implementations, the action can be taken by the compute device, robot, equipment, and/or the like without human intervention. For example, if the recommended action is to dig to a certain depth, a robot can dig to that certain depth without human intervention.

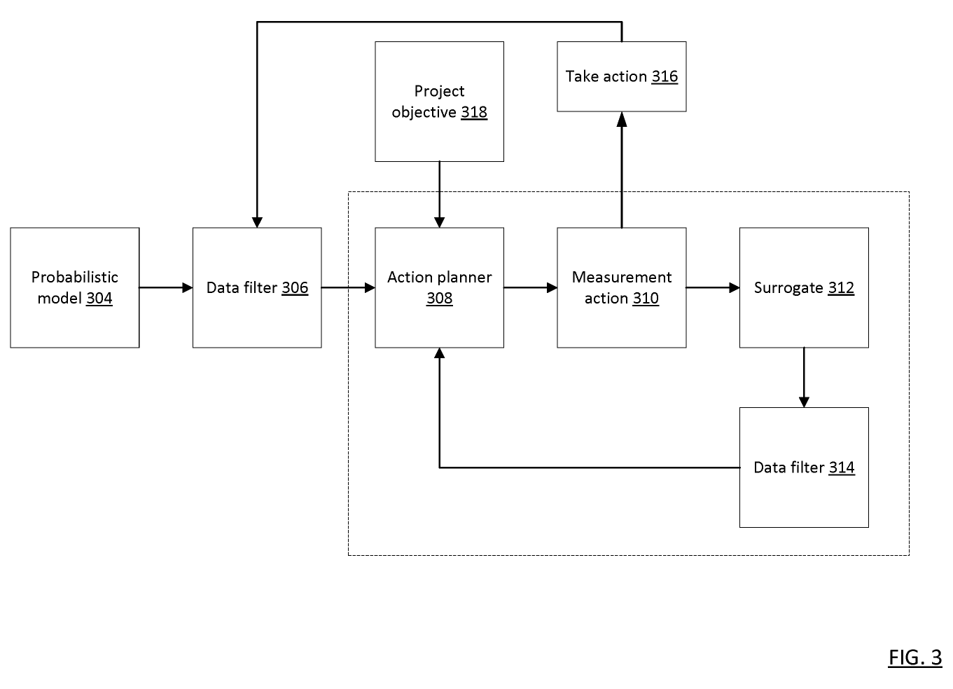

In some implementations, a closed loop simulation is used to directly estimate the value of information. Some techniques used for the closed loop simulation include:
a. Neural surrogates in the loop. Computing desirable (e.g., optimal) solutions with desirable accuracy can use thousands to millions of simulated sequences. Doing this at scale with some known simulation techniques would be intractable. Therefore, some implementations use a surrogate model (e.g., neural surrogate model) that simulates hundreds of thousands of times faster than some known simulation techniques directly into the decision loop.
b. Multi-Mode data filter. To update a probabilistic world model for steps in the loop using some known particle filtering or other common methods would be intractable for high dimensional geological problems. Some implementations use an efficient multi-modal filter that approximates the full posterior for both direct drill observations and indirect geophysical measurements (e.g., as discussed with respect to data filter 306 and/or 314 of FIG. 3).
c. Quantitative Validation. Some known sampling based optimization methods that are used for sequential task optimization are stochastic by nature. Some implementations use validation metrics that can be used to quantify the deviation from expected returns from both the sampling in the simulation process and the use of the neural surrogates. For example, for a given action recommendation, return variation between each simulated action sequence that starts with that action can be analyzed. This variance can be used to validate expected performance bounds. Additional simulations can be without the surrogate (e.g., using the "true" simulation, where "true" can refer to a high-fidelity physics-based simulation as opposed to a simulation result(s) output from the surrogate) to further tighten those bounds as desired.

In some implementations, a subsurface resource exploration process includes multiple steps performed in sequence and/or order, such as locating potential deposits, surface exploration, early-stage exploration, core drilling, resource modeling, de-risking, and/or the like. Some implementations are related to, for each stage in a subsurface resource exploration process, generating a recommended action(s) for that stage based on a geological model, receiving outcome data (e.g., results) based on what happened in the physical and/or real world in response to performing the recommended action(s), and generating an updated geological model based on the outcome data, where the aforementioned process can be repeated using the updated geological model to generate a recommended action for the next stage in the subsurface resource exploration process. Said similarly, a geological model is updated iteratively as actions are recommended for a stage in the subsurface resource exploration process and outcome data is received based on what happened in response to taking the recommended actions.

To provide an example, a first stage in a subsurface resource exploration process can be locating potential deposits. A first geological model is generated representing a geological site, and a recommended action is determined based on the first geological model. For example, the recommended actions can be to gather soil samples, measure seismic activity, identify rock types, and/or the like. After actually performing the recommended actions, a user can provide outcome data indicating the results from taking the recommended action, such as what the moisture level of the soil samples was, a seismic return or signal, the type and/or amount of rocks found, and/or the like. That outcome data can then be used to update the first geological model and generate a second geological model. The second geological model can incorporate (and/or otherwise be updated based on) the outcome data (e.g., to reflect the measured moisture level of the soil, the level of seismic activity, the type and/or amount of rocks found, and/or the like). Thereafter, the second geological model can be used for a second stage in the subsurface resource exploration process. For example, if the second stage is subsurface exploration, the recommended action can be to excavate at a certain region of the geological site. After actually digging at that region, outcome data can be provided (e.g., what minerals were found, where the minerals were found, how many minerals were found, etc.) and the outcome data can be used to update the second geological model and generate a third geological model that can be used to generate a recommended action for a third stage of the subsurface resource exploration process. Such a process can occur for each stage of the subsurface resource exploration process until a stopping criterion is met (e.g., the subsurface resource exploration process is complete, a budget is exceeded, a goal is met, a user ends the process, etc.).

For each stage of the subsurface resource exploration process, generating a recommended action for that stage can include iteratively determining and testing one or more potential actions, following, for example, a reinforcement-learning-type of approach (e.g., a trained reinforcement learning model) and/or a Monte Carlo planning/searching-type approach. For example, generating a recommended action for that stage can include iteratively determining potential actions, simulating those potential actions (e.g., using a neural surrogate model), and generating updated geological models (e.g., that incorporate those potential actions) until a set of stopping criteria is met.

Accordingly, some techniques resemble a compute device performing a nested loop that includes an "outer loop" and an "inner loop." Each iteration of the outer loop includes generating a recommended action based on an initial geological model, receiving outcome data in response to the recommended action, and updating the prior geological model to generate an updated geological model based on the outcome data, where that iteration of the outer loop performs an inner loop to generate the recommended action by considering potential actions in view of project objective.

In some implementations, the nested loop can perform multiple iterations at a given stage of a subsurface resource exploration process. For example, if a stage is drilling, a geological model can represent a site with multiple (e.g., hundreds) of drilled holes, and the nested loop can be run based on the geological model to target each individual hole (e.g., where the geological model is divided based on the drilled holes and different outer loop iterations are performed at different drilled holes and/or segments of the geological model). Thus, for example, a recommended action can be generated for each individual hole such that multiple recommended actions are provided for a stage of the subsurface resource exploration process. The outer loop can, for example, perform multiple iterations and generate multiple recommended actions for a given stage until a predetermined stopping criterion is met (e.g., a predetermined amount of time has passed, a predetermined amount of iterations have been performed, no more recommended actions can be generated, and/or the like).

Some implementations run massive numbers of simulations. For example, millions of simulations can be run to identify potential actions and predict the effects of those potential actions for each stage of a multi-stage process, accounting for thousands of different variables and how those variables interplay with one another.

Some implementations use a surrogate model (e.g., neural surrogate model) to, for example, consider how a potential action would affect a geological model. Compared to some known techniques, which don't use a surrogate model, predictions (simulations) can be performed much faster by a computer using the surrogate model. The surrogate model can also more effectively, compared to some known simulation techniques, manage a large number of data and/or high-dimensional data, which can be particularly desirable in subsurface resource exploration given the large amount of complex data under consideration. Moreover, the surrogate model can generalize better from a training set and therefore offer more accurate predictions compared to some known simulation techniques (that use interpolation).

Some implementations can provide recommended actions and/or generate updated models at a common location (e.g., a common server) for multiple different users that are specific and/or custom to each of the different users. Said similarly, a common compute device can receive data from multiple different compute devices, perform processing at the common compute device that is specific to the data received from each of the different compute devices, and deliver client- specific outcomes to each of the different compute devices.

Some implementations solve (or at least mitigate) technical problems of some known simulation techniques using a technical solution. For example, to address massive amounts of data for a simulation that burden and/or cannot be processed by some known techniques, a surrogate model is used. As another example, to address inaccurate predictions made by some known techniques, a geological model is updated incrementally based on additional data received incrementally (rather than only updating a geological model once).

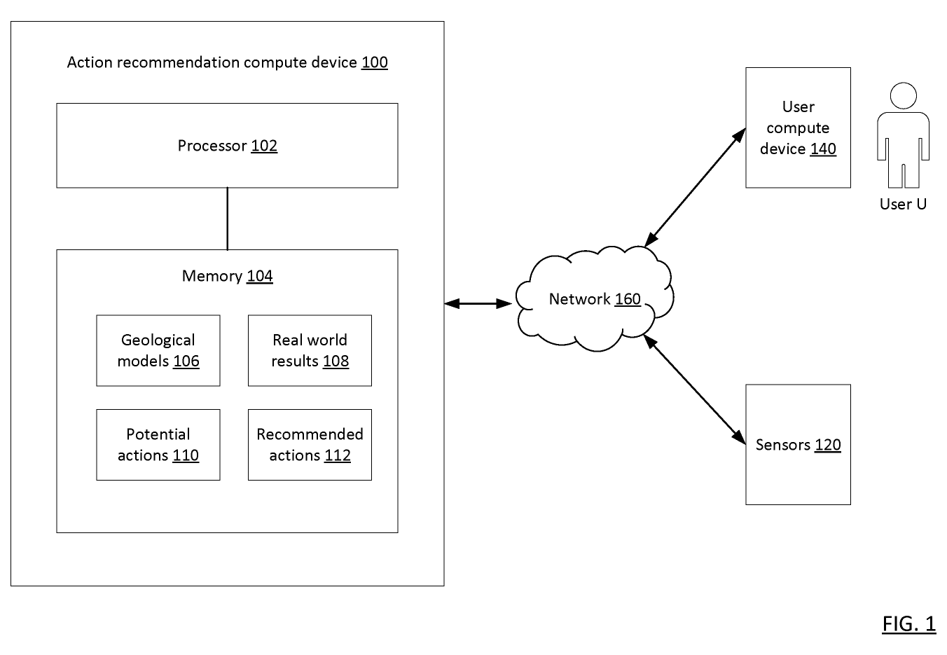

FIG. 1 illustrates a system block diagram to repeatedly generate recommended actions and update geological models based on actions taken in response to the recommended actions, according to an embodiment. FIG. 1 illustrates action recommendation compute device 100, sensors 120, and user compute device 140, each operatively coupled to one another via network 160.

The network 160 can be any suitable communications network for transferring data, operating over public and/or private networks. For example, the network 160 can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the network 160 can be a wireless network such as, for example, a Wi-Fi or wireless local area network ("WLAN"), a wireless wide area network ("WWAN"), and/or a cellular network. In some instances, the network 160 can be a wired network such as, for example, an Ethernet network, a digital subscription line ("DSL") network, a broadband network, and/or a fiber-optic network. In some instances, the network can use Application Programming Interfaces (APIs) and/or data interchange formats, (e.g., Representational State Transfer (REST), JavaScript Object Notation (JSON), Extensible Markup Language (XML), Simple Object Access Protocol (SOAP), and/or Java Message Service (JMS). The communications sent via the network 160 can be encrypted or unencrypted. In some instances, the network 160 can include multiple networks or subnetworks operatively coupled to one another by, for example, network bridges, routers, switches, gateways and/or the like (not shown).

Sensors 120 can include one or more sensors to collect sensor data and monitor the geological site. In some implementations, sensors 120 includes sensors that can be used for subsurface resource exploration and development, such as to gather relevant data that can be used to predict what resources are located where. Examples of sensors 120 include seismic sensors, magnetometers, electromagnetic induction sensors, electrical resistivity tomography sensors, downhole cameras, temperature and pressure sensors, gas analyzers, soil gas sensors, acoustic emission sensors, satellite sensors, and/or the like. In some implementations, tests, measurements, and/or other experiments can be run using sensor data collected by sensors 120 (e.g., in a lab). For example, sensor data may include images or samples of rocks, and measurements can be run to estimate the rocks' age(s).

Action recommendation compute device 100 and/or user compute device 140 can be any type of compute device, such as a server, desktop, laptop, tablet, phone, internet-of-things device, and/or the like. Action recommendation compute device 100 includes processor 102 communicatively coupled to memory 104 (e.g., via a system bus). Although not shown in FIG. 1, user compute device 140 and/or sensors 120 can also each include a processor operatively coupled to a memory (e.g., via a system bus).

Each processor (e.g., processor 102, processor of user compute device 140 (not shown in FIG. 1, processor of each sensor 120 (not shown in FIG. 1), etc.) can be, for example, a hardware based integrated circuit (IC) or any other suitable processing device configured to run and/or execute a set of instructions or code. For example, the processor 102 can be a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. The processor 102 can be operatively coupled to the memory 104 through a system bus (for example, address bus, data bus and/or control bus). Each memory (e.g., memory 104, memory of user compute device 140 (not shown in FIG. 1, memory of each sensor 120 (not shown in FIG. 1), etc.) can be, for example, a random-access memory (RAM), a memory buffer, a hard drive, a read-only memory (ROM), an erasable programmable read-only memory (EPROM), and/or the like. In some instances, the memory 104 can store, for example, one or more software programs and/or code that can include instructions to cause the processor 102 to perform one or more processes, functions, and/or the like. In some embodiments, the memory 104 can include extendable storage units that can be added and used incrementally. In some implementations, the memory 104 can be a portable memory (e.g., a flash drive, a portable hard disk, and/or the like) that can be operatively coupled to the processor 102. In some instances, the memory 104 can be remotely operatively coupled with a compute device (not shown). For example, a remote database device can serve as a memory and be operatively coupled to the compute device.

Memory 104 can include (e.g., store) geological models 106, potential actions 110, real world results 108, and recommended actions 112. Geological models 106 can include multiple geological models representing the surface and/or subsurface conditions of a geological site. Geological models 106 can represent geological models generated by both the inner loop and outer loop. For example, geological models 106 can include (1) geological models generated based on real world results 108 at the outer loop and (2) geological models generated based on potential actions 110 at the inner loop. In some implementations, geological models 106 are probabilistic geological models. In some implementations, at least one geological model from geological models 106 is generated using the systems and methods shown and described in U.S. Patent Application No. 63/726,424 (filed Nov. 29, 2024) of U.S. Patent Application No. 19/394,413 (filed Nov. 19, 2025) (e.g., an initial geological model used to consider an initial potential action is a collected 3D geological model, real world results input to the multi-mode embedding encoder to generate updated geological models), the contents of each of which are incorporated by reference herein in their entirety.

Recommended actions 112 can represent actions that are recommended to be taken in the physical and/or real world. In some implementations, recommended actions 112 include one or more resource exploration plans, such as where to explore and not to explore for resources, how to explore, when to explore, what types of resources are likely or unlikely, environmental risks to avoid and/or be cautious of, what equipment can be used, a budget, and/or the like. Recommended actions 112 can be generated for one or more stages of a subsurface resource exploration process. For example, if the subsurface resource exploration process has multiple stages, one or more recommended actions can be generated for each stage. Therefore, in some implementations, action recommendation compute device 100 is configured to perform an outer loop, where each iteration of that outer loop generates a recommended action included in recommended actions 112 for a different stage in the surface resource exploration process. Further, after a recommended action is generated for an iteration, results from taking the recommended action in the physical and/or real world can be received at action recommendation compute device 100, saved as real world results 108, and used to generate an update geological model (included in geological models 106) that is then used to generate a recommended action for the subsequent iteration. In some implementations, recommended actions 112 can be performed automatically without human involvement. In such implementations, for example, a signal can be automatically sent from action recommendation compute device 100 to a device (e.g., a machine) at the geological site to perform the recommended action. For example, a signal can be automatically sent to a boring machine to drill a hole in a specific area of the geological site. For another example, a signal can be automatically sent to a machine to take and/or analyze a soil sample at a specific area of the geological site. In yet another example, a signal can be automatically sent to a machine to capture and analyze an image of a specific area of the geological site. In some implementations, a signal can be sent to instruct a human to perform the recommended action.

Real world results 108 can represent the results of taking an action from recommended actions 112. Examples of real world results include what resource was found, where a resource was found, how much of a resource was found, sensor data captured by sensors 120, results of tests, measurements, and/or other experiments run based on and/or using sensor data captured by sensors 120, identification of rock layers, structural geology data, seismic data, magnetic and gravity data, electromagnetic data, soil and water sample data, vegetation and other surface conditions, cost data, market prices, and/or any other data useful to determine the effects of taking a recommended action. In some implementations, real world results 108 are received at action recommendation compute device 100 from sensors 120, user compute device 140, and/or a compute device not shown in FIG. 1. In some implementations, a user interface requests certain data (e.g., from user U) representing the metrics to be collected. For example, action recommendation compute device 100 can determine what metrics to collect (e.g., using a lookup table that identifies metrics to collect for a given stage of a subsurface resource exploration process), a representation of at least some of those metrics can be sent to user compute device 140, user compute device 140 can display those metrics via the user interface, user U can provide measured values for those metrics via the user interface, and those user-provided values can be sent to action recommendation compute device 100.

Recommended actions 112 can be generated based on potential actions 110. Potential actions 110 can represent actions that can potentially be performed at a geological site / simulated at a given geological model from geological models 106. Said similarly, potential actions 110 can be candidate actions. For example, for a first geological model from geological models 106, a first potential action from potential actions 110 can be determined based on the first geological model and a project objective (e.g., goals of the subsurface exploration process such as, for example, the type of resource to locate, how much of the resource to locate, the economic constraints, the environmental and/or regulatory constraints, and/or the like) to generate a second geological model that represents the first geological model with the first potential action having occurred.

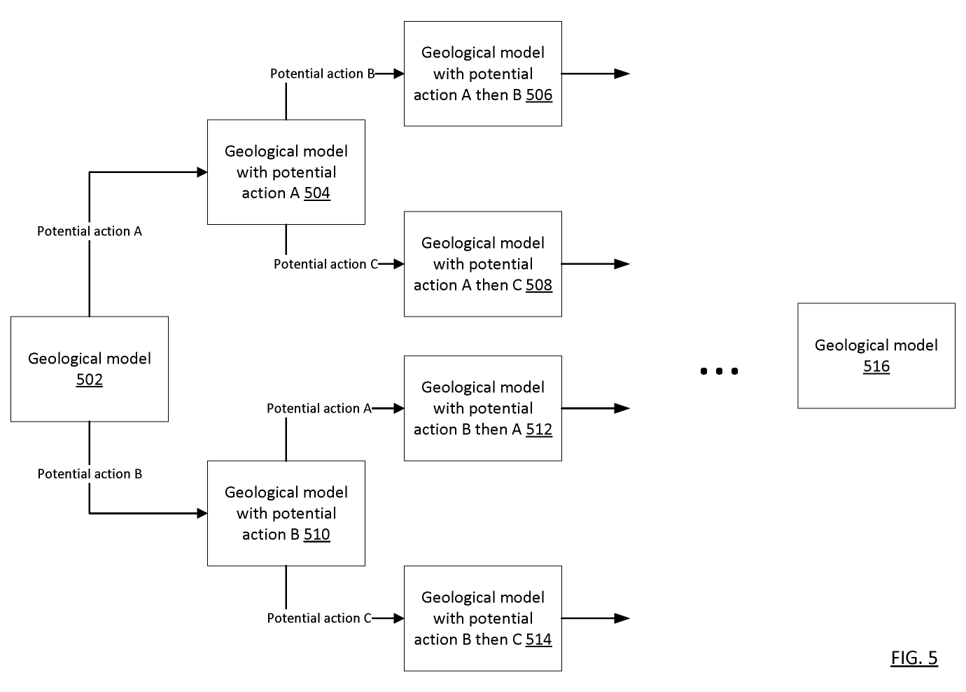

Potential actions can be repeatedly determined and geological models can be repeatedly modified, generated, updated, and/or otherwise account for potential actions taking place until a predetermined set of criteria are met, such as a threshold number of iterations, a threshold amount of time spent iterating, a geological site having certain predetermined characteristics, and/or the like. Therefore, in some implementations, action recommendation compute device 100 is configured to perform an inner loop, where each iteration of that inner loop simulates a potential action included in potential actions 110 for a given outer loop iteration and/or stage in the surface resource exploration process. Said similarly, to generate a recommended action for a given stage, multiple potential actions can be considered and simulated in the inner loop. Further, the multiple potential actions can be considered in various combinations, sequences, and subsets. For example, for a given set of potential actions, each possible subset of potential actions from the set of potential actions can be considered in various possible sequences. As different potential actions are determined and/or tested, geological models can be tweaked to incorporate those potential actions taking place. Additional details related to considering multiple potential actions are discussed with respect to FIG. 5.

In some implementations, the first iteration in an inner loop determines a potential action based on a first geological model and project objective, simulates the potential action at the first geological model (e.g., using a neural surrogate model) to generate a second geological model (e.g., that is a modified version of the first geological model with the potential action having occurred), and repeats the process of determining a recommended action and simulating the potential action using the latest generated geological model (e.g., the second geological model) in place of the prior generated geological model (e.g., the first geological model) to generate a new geological model (e.g., third geological model) until a predetermined set of stopping criteria are met and the recommended action is determined. In some implementations, as described herein, simulating a potential action at an X (where X is a positive integer) geological model in the inner loop to generate an X+1 geological model refers to the X+1 geological model having the same underlying assumptions as the Xgeological model but in combination with the potential action and simulated outcome, result and/or effect of the potential action at the X geological model. Said similarly, the X geological model is taken and the potential action is added to the X geological model (e.g., such that the potential action now exists at the X geological model) to create the X+1 geological model.

In some implementations, potential actions 110 can be determined using a reinforcement learning approach (e.g., using a trained reinforcement learning model). For example, determining potential actions 110 based on a geological model can include using the geological model as the state space and the project objective as the goal. As such, the geological model and the project objective can be input or provided to a reinforcement learning model to identify possible actions. Further, possible actions can be determined, such as excavating a certain location, collecting certain types of data, performing actions at certain times, and/or the like. To evaluate the actions, the objective or reward function can be determined based on a project objective that outlines the goals of the subsurface exploration process (e.g., the type of resource to locate, how much of the resource to locate, the economic constraints, the environmental and/or regulatory constraints, etc.). Potential actions 110 can then be determined by exploring the different possible actions in the state space and evaluating those different actions using the objective or reward function and based on the project objective. Potential actions 110 can be, for example, those actions that provide the most reward and/or are least penalized. In some implementations, a neural surrogate model can be used during the reinforcement learning. For example, an agent can predict the outcomes of different actions in different states using a surrogate model trained to predict outcomes based on actions. As another example, the surrogate model can help the agent predict the likely rewards of various actions (e.g., speeding up the learning process). Additional details on the surrogate model are further described elsewhere herein.

In some implementations, the predicted results (e.g., simulated outputs) of taking potential actions 110 can be determined using a reinforcement learning approach (e.g., using a trained reinforcement learning model). For example, predicting the results of taking potential actions 110 can include using the geological model as the state space. Further, possible actions can be determined, such as excavating a certain location, collecting certain types of data, performing actions are certain times, and/or the like. To evaluate the actions, the objective or reward function can be determined based on a project objective that outlines the goals of the subsurface exploration process (e.g., the type of resource to locate, how much of the resource to locate, the economic constraints, the environmental and/or regulatory constraints, etc.). Predicted results can then be determined by determining, after exploring the different possible actions in the state space and evaluating those different actions using the objective or reward function, the outcome of those actions that provide the most reward and/or are least penalized.

In some implementations, at least some actions from potential actions 110 become recommended actions 112. In some implementations, for a given stage and/or outer loop iteration, the potential actions from potential actions 110 that led up to generating the geological model satisfying the predetermined set of criteria can be considered the recommended action(s) for that stage and/or outer loop iteration. In some implementations, the next, prior and/or latest action in the inner loop that generated the geological model satisfying the predetermined set of criteria can be considered the recommended action (included in recommended actions 112) for that stage and/or outer loop iteration.

In some implementations, simulating a potential action using a geological model includes simulating the potential action using a neural surrogate model. For example, in some implementations, a neural surrogate model mimics the behavior of a simulation model while being computationally cheaper to evaluate. Said similarly, surrogate models are approximations of simulations models, where the surrogate models can be faster and less computationally complex than the simulations models by, for example, using more parallel operation. In some implementations, the neural surrogate model is trained using a training dataset, such as a training dataset generated by running non-surrogate models. The training dataset can include, for example, input-output pairs where the inputs are actions and the outputs are results of the actions. After training, the neural surrogate model can be configured to receive potential actions and predict the results of the received potential actions without running the non-surrogate models. In some implementations, the neural surrogate model can be repeatedly updated and/or retrained using, for example, additional potential actions (e.g., potential actions 110) as they are determined during inner loop iterations (as input training data) and/or additional real world results (e.g., real world results 108) as they are received during outer loop iterations. This retraining can result in a surrogate model that is more accurate.

To provide an example, for a first stage in a subsurface resource exploration, a first potential action from potential actions 110 can be determined based on a first geological model from geological models 106 and a project objective. The first potential action can then be simulated (e.g., using a neural surrogate model) to generate a first simulated output indicating, for example, the result and/or confidence level of performing the first potential action. The first simulated output can then be used to update the first geological model and generate a second geological model. If the second geological model satisfies a predetermined set of stopping criteria (e.g., a certain amount of a resource is predicted to be found), a recommended action included in recommended actions 112 can be generated based on the second geological model (the recommended action could be, for example, the potential action that resulted in the geological model that now satisfied the predetermined set of stopping criteria, which in this case would be the first potential action). If, however, the second geological model does not satisfy the predetermined set of stopping criteria, a recommended action is not determined and instead a second potential action is determined based on the second geological model and the project objective, the second potential action is simulated to generate a second simulated output indicating the results and/or confidence level of performing the second potential action, and the second simulated output is used to update the second geological model and generate a third geological model. If the third geological model satisfied the predetermined set of stopping criteria, a recommended action included in recommended actions 112 can be generated based on the third geological model (the recommended action could be, for example, the potential action that resulted in the geological model that now satisfied the predetermined set of stopping criteria, which in this case would be the second potential action). If, however, the third geological model does not satisfy the predetermined set of stopping criteria, a recommended action is not determined and instead the same process used to generate the third geological model is repeated to generate a third potential action and a fourth geological model. The aforementioned process can occur iteratively until a geological model is generated that satisfies the predetermined set of stopping criteria and a recommended action is generated. Further, after the recommended action for the first stage is generated, results from taking the recommended action can be received. For example, the recommended action for the first stage can be output to user U at user compute device 140, user U can perform (or have someone else perform) the recommended action in the physical and/or real world, and user U can provide data (e.g., at user compute device 140 and/or action recommendation compute device 100) on what happened as a result of taking the recommended action in the physical and/or real world (saved as part of real world results 108). The data representing what happened as a result of taking the recommended action can then be used to update the first geological model and generate an updated geological model (saved in geological models 106) that can be used in the subsequent stage of the subsurface resource exploration process. Specifically, potential actions (e.g., included in potential actions 110) can be determined using the updated geological model (e.g., instead of the first geological model) until a recommended action (e.g., included in recommended actions 112) is determined for that subsequent stage, results from taking the recommended action for that subsequent stage are received (and saved as part of real world results 108), and results from taking the recommended action for that subsequent stage are used to further update the updated geological model to repeat the aforementioned process until the stages of the subsurface resource exploration have been completed.

To provide another example, reference is made to FIG. 5. FIG. 5 illustrates a flow process to consider various combinations of potential actions at a stage of a subsurface exploration process, according to an embodiment. FIG. 5 can represent inner loop iterations to determine a recommended action to take in the physical and/or real world. Geological model 502 can represent a geological model generated at an outer loop iteration. For example, geological model 502 can represent a geological model that has been updated based on taking a recommended action in the real / physical world. In some implementations, for example, geological model 502 can correspond to probabilistic model 304 in FIG. 3.

From geological model 502, various potential actions can be considered and/or simulated. For example, potential action A at geological model 502 can be simulated to generate at 504 a geological model that doesn't change the underlying assumptions and/or characteristics of geological model 502 but now includes a version of geological model 502 (e.g., the underlying assumptions or characteristics of geological model 502) where potential action A has occurred. Then, geological model from 504 can be used to simulate potential action B to generate at 506 a geological model that doesn't change the underlying assumptions and/or characteristics of the geological model from 504 but now includes a version of the geological model from 504 where potential action B occurred after potential action A. Similarly, geological model from 504 can be used to simulate potential action C to generate at 508 a geological model that doesn't change the underlying assumptions and/or characteristics of the geological model from 504 but now includes a version of the geological model from 504 where potential action C was performed after potential action A.

A similar process can occur where other potential actions are considered for geological model 502. For example, potential action B at geological model 502 can be simulated to generate at 510 a geological model that doesn't change the underlying assumptions and/or characteristics of geological model 502 but now includes a version of geological models 502 where potential action B occurred. Then, geological model from 504 can be used to simulate potential action A to generate at 512 a geological model that doesn't change the underlying assumptions and/or characteristics of the geological model from 510 but now includes a version of the geological model from 510 where potential action A occurred after potential action B. Similarly, geological model from 510 can be used to simulate potential action C to generate at 514 a geological model that doesn't change the underlying assumptions and/or characteristics of the geological model from 510 but now includes a version of the geological model from 510 where potential action C occurred after potential action B. Ultimately, various combinations of potential actions can be considered in various orders, and one or more combinations can results in a desirable (e.g., satisfying a predetermined set of criteria) geological model-geological model 516 (e.g., a goal of the process). The one or more combinations that result in desired geological model 516 in an efficient manner can be the recommended action to take in the real world. In some implementations, the next action in a simulated and/or predicted desirable chain of actions is provided as the recommended action. In some implementations, multiple actions in a simulated and/or predicted desirable chain of actions are provided as the recommended action.

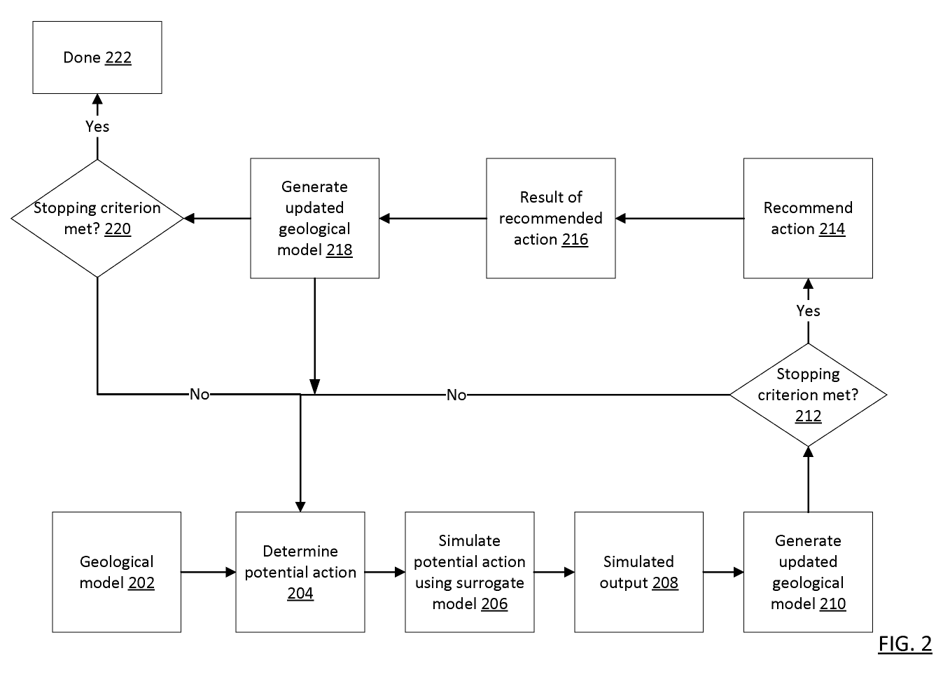

Although FIG. 1 illustrates an example, variations can exist in other embodiments. For example, although FIG. 1 illustrates three different sets of compute devices (action recommendation compute device 100, user compute device 140, and sensors 120), in other implementations, more or less compute devices can be used. For instance, in some implementations, the functionalities of action recommendation compute device 100 are divided across multiple compute devices (e.g., a first compute device generates geological models 106 and a second compute device generates recommended actions 112). As another example, in some implementations, the functionalities of user compute device 140 and action recommendation compute device 100 are combined into a single compute device. FIG. 2 illustrates a nested loop flow process to repeatedly update geological models based on potential actions and results of recommended actions, according to an embodiment. In some implementations, the flow process illustrated in FIG. 2 includes code stored in a memory (e.g., memory 104 of FIG. 1) and is executed and/or performed by a processor (e.g., processor 102 of FIG. 1). The flow process in FIG. 2 illustrates an inner loop to determine a recommended action for a geological model and an outer loop where each iteration of the outer loop corresponds with and/or is associated with a stage in a subsurface resource exploration process.

At 202, a geological model (e.g., included in geological models 106) is received and/or generated. The geological model can represent the geological model for a site that is subject to (or potentially subject to) a subsurface resource exploration process.

At 204, a potential action is determined. In some implementations, the potential action is determined based on geological model 202 and a project objective (e.g., goals of the subsurface exploration process like the type of resource to locate, how much of the resource to locate, the economic constraints, the environmental and/or regulatory constraints, and/or the like). For example, a reinforcement learning-type of process (e.g., based on a trained reinforcement learning model) can occur where geological model 202 is the environment, an agent interacts with the environment to explore different states and actions, and the project objective informs the feedback given to the agent. In some implementations, the potential action is determined using a neural network (e.g., trained using geological models and/or project objectives as input learning data and potential actions as target learning data) configured to receive geological models 202 and/or the project objective and output a potential action.

At 206, the potential action determined at 204 is simulated using a surrogate model (e.g., neural surrogate model) to generate simulated output 208. In some implementations, the surrogate model evaluates a set of points (e.g., design points, simulation runs) at geological models 202, builds simulated output 208 by approximating the behavior of the set of points, and optionally performs refinement of simulated output 208 (e.g., by exploring different configurations). Simulated output 208 can represent, for example, the effects that performing the potential action determined at 204 would have on geological model 202. Accordingly, at 210, simulated output 208 can be used to generate an updated geological model. For example, simulated output 208 can be incorporated into geological models 202 so that simulated output 208, representing how the potential action determined at 204 affects geological model 202, is incorporated into the updated geological model at 210.

At 212, a determination is made whether a stopping criterion is met. The stopping criterion can be, for example, whether the updated geological model generated at 210 satisfies a predetermined set of acceptable criteria (e.g., a confidence level is above a predetermined threshold, the results are desirable, a minimum amount of a particular resource is simulated to be found, etc.), whether a threshold amount of time has passed, whether a minimum amount of inner loop iterations have occurred, whether a user has manually requested stoppage, and/or the like.

If the stopping criterion is not met at 212, additional potential actions are determined and simulated at 204 to 212. For example, different combinations of potential actions can be simulated in different orders using, for example, geological model 202 or a modified version of geological model 202 that incorporates a potential action(s) (e.g., as discussed with respect to FIG. 5).

If the stopping criterion is met at 212, a recommended action is determined and/or output at 214. The recommended action can be, for example, the potential action determined at 204 that led to the stopping criterion being met at 212 and/or one or more potential actions determined at 204 that did not lead to the stopping criterion being met at 212.

At 216, results of taking the recommended action 214 are received. For example, after a user takes recommended action 214, the user provides values for metrics that represent the effects of taking recommended action 214.

At 218, an updated geological model is generated. In some implementations, geological model 202 is updated based on the results from 216 to generate the updated geological model at 218. Said similarly, rather than generating the updated geological model at 218 using an updated geological model from 210, the updated geological model at 218 is generated using geological model 202 and the results from 216.

At 220, a determination is made whether a stopping criterion is met. The stopping criterion can be, for example, whether any stages of subsurface resource exploration process remain.

If the stopping criterion is met at 220, the process completes at 222. If the stopping criterion is not met at 220, however, 204 to 218 is performed again (e.g., for a different stage of the subsurface resource exploration process). In this iteration, however, the updated geological model generated at 218 is used instead of geological model 202. Said similarly, each outer loop iteration results in an updated geological model at 218 that is then used in the subsequent outer loop iteration if the stopping criterion is not met at 220.

FIG. 3 illustrates a flow process to take and measure actions, according to an embodiment. The flow process at FIG. 3 illustrates a nested loop process that includes an inner loop and outer loop, where the inner loop includes 308, 310, 312, and 314.

At the first iteration of the outer loop, a probabilistic model (e.g., from geological models 106) is received. At 306, a data filter determines if probabilistic model 304 is to be updated based on whether a preceding action has been taken at 316. Since the first iteration of the outer loop is taking place, there is no preceding action yet from 316 so data filter 306 does not update probabilistic model 304.

Thereafter, the first iteration of the inner loop process occurs for the first iteration of the outer loop. Action planner 308 determines a potential action to take based on probabilistic model 304 and project objective 318. Measurement action 310 simulates the potential action from 308 using surrogate 312 (e.g., a neural surrogate model), and surrogate 312 generates a simulated output. Data filter 314 generates an updated geological model by updating the geological model that was used to generate the updated geological model (e.g., by determining the potential action and simulating the potential action) based on the simulated output. If the updated geological model does not satisfy a set of predetermined criteria, the inner loop is repeated to consider additional combinations and sequences of potential actions (e.g., as described with respect to FIG. 5).

If the updated geological model satisfies a set of predetermined criteria, a recommended action is determined at 308. Measurement action 310 identifies the data and/or other metrics that should be tracked to assess the real-world impact of implementing the recommended action. At 316, the recommended action is taken (e.g., by a human, by a computer, by machinery, etc.) and the data and/or values for other metrics identified at 310 are received at data filter 306.

At the second iteration of the outer loop, data filter 306 determines that probabilistic model 304 is to be updated since an action took place at 316. Accordingly, data filter 306 updates probabilistic model 304 based on the data and/or values for other metrics captured at 316. Thereafter, the same inner loop process (308 to 314) occurs using the updated probabilistic model from 304 until a set of predetermined criteria are satisfied and a recommended action is generated to cause an action to take place at 316.

The aforementioned description with respect to FIG. 3 describes two iterations of the outer loop, however, any number of outer loop iterations can occur. For example, the number of outer loop iterations can correspond with the number of stages in a subsurface resource exploration process. As each iteration of the outer loop generates an updated probabilistic model at 304, the iteration of the outer loop subsequent to that iteration of the outer loop can further update the updated probabilistic model at 304 based on the latest action taken place at 316 (for the iteration of the outer loop subsequent to that iteration of the outer loop) to generate yet another updated probabilistic model.

In some implementations, the model used to predict potential actions (in the inner loop; e.g., action planner 308) is re-trained based on the results from 316. For example, the model can be re-trained using probabilistic model 304 (e.g., as input learning data) and the results from 316 (e.g., as target learning data). That way, as the model is re-trained, the model can make more accurate predictions as to, for example, what combination and/or sequence of potential actions to take and/or what a resulting geological model will be.

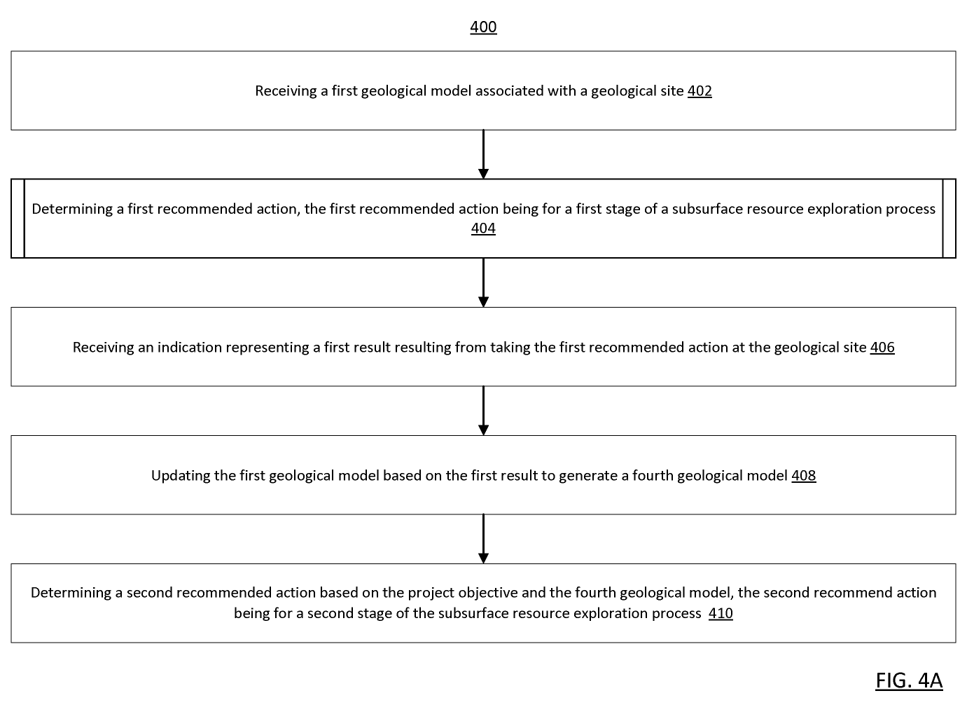

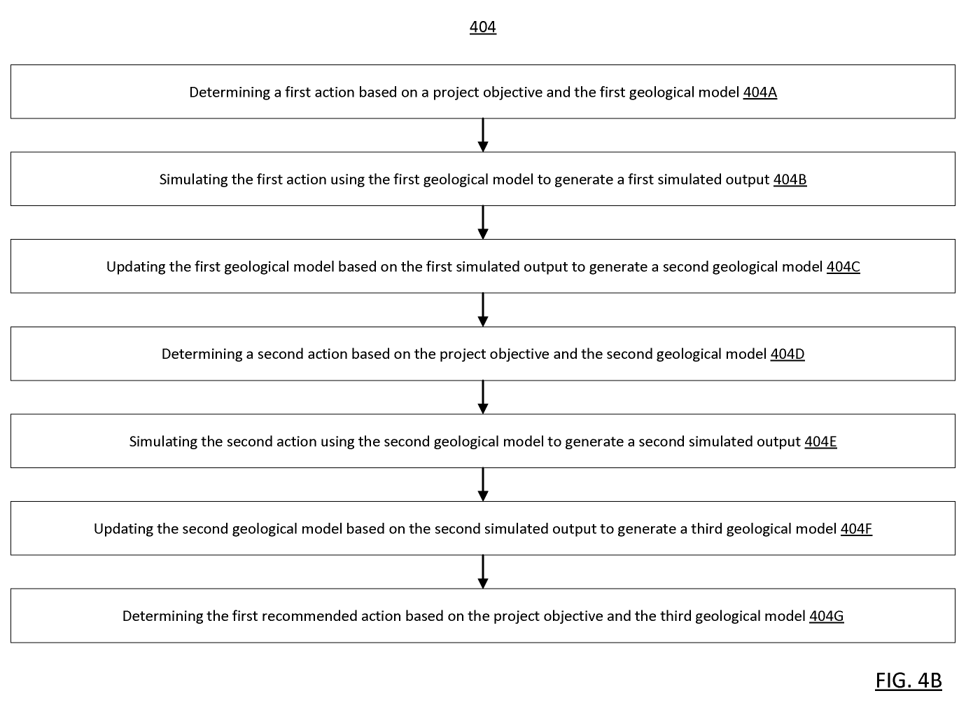

FIGS. 4A and 4B illustrate a flowchart of a method 400 to determine recommended actions for stages of a subsurface resource exploration process, according to an embodiment. In some implementations, method 400 includes code stored in a memory (e.g., memory 104 of FIG. 1A) and executed and/or performed by a processor (e.g., processor 102 of FIG. 1A).

At 402, a first geological model (e.g., included in geological models 106) associated with a geological site is received.

At 404, a first recommended action (e.g., included in recommended actions 112) is determined for a first stage of a subsurface resource exploration process. FIG. 4B illustrates a flowchart of a method to determine the first recommended action. At 404A, a first action (e.g., included in potential actions 110) is determined based on a project objective and the first geological model. At 404B, the first action is simulated using the first geological model to generate a first simulated output. At 404C, the first geological model is updated based on the first simulated output to generate a second geological model (e.g., included in geological models 106). At 404D, a second action (e.g., included in potential actions 110) is determined based on the project objective and the second geological model. At 404E, the second action is simulated using the second geological model to generate a second simulated output. At 404F, the second geological model is updated based on the second simulated output to generate a third geological model (e.g., included in geological models 106). At 404G, the first recommended action is determined based on the project objective and the third geological model. In some implementations, 404 occurs automatically (e.g., without human intervention) in response to completing 402.

At 406, an indication representing a first result (e.g., included in real world results 108) resulting from taking the first recommended action at the geological site is received.

At 408, the first geological model is updated based on the first result to generate a fourth geological model (e.g., included in geological models 106). In some implementations, 408 occurs automatically (e.g., without human intervention) in response to completing 406.

At 410, a second recommended action (e.g., included in recommended actions 112) is determined based on the project objective and the fourth geological model, where the second recommended action is for a second stage of the subsurface resource exploration process. In some implementations, 410 occurs automatically (e.g., without human intervention) in response to completing 408.

In some implementations of method 400, determining the second recommended action at 410 includes determining a third action (e.g., included in potential actions 110) based on the project objective and the fourth geological model. The third action is simulated using the fourth geological model to generate a third simulated output. The fourth geological model is updated based on the third simulated output to generate a fifth geological model (e.g., included in geological models 106). A fourth action (e.g., included in potential actions 110) is determined based on the project objective and the fifth geological model. The fourth action is simulated using the fifth geological model to generate a fourth simulated output. The fifth geological model is updated based on the fourth simulated output to generate a sixth geological model (e.g., included in potential actions 110). The second recommended action is determined based on the project objective and the sixth geological model.

Some implementations of method 400 further include receiving an indication representing a second result (e.g., included in real world results 108), where the second result results from taking the second recommended action at the geological site. The fourth geological model is updated based on the second result to generate a fifth geological model (e.g., included in geological models 106) and a third recommended action (e.g., included in recommended actions 112) for a third stage of the subsurface resource exploration process is determined based on the project objective and the fifth geological model.

In some implementations of method 400, the first geological model is a first probabilistic geological model, the second geological model is a second probabilistic geological model, the third geological model is a third probabilistic geological model, and the fourth geological model is a fourth probabilistic geological model.

In some implementations of method 400, simulating the first action using the first geological model to generate the first simulated output at 404B further includes simulating the first action using a neural surrogate model and the first geological model to generate the first simulated output, and simulating the second action using the second geological model to generate the second simulated output at 404E further includes simulating the second action using the neural surrogate model and the second geological model to generate the second simulated output.

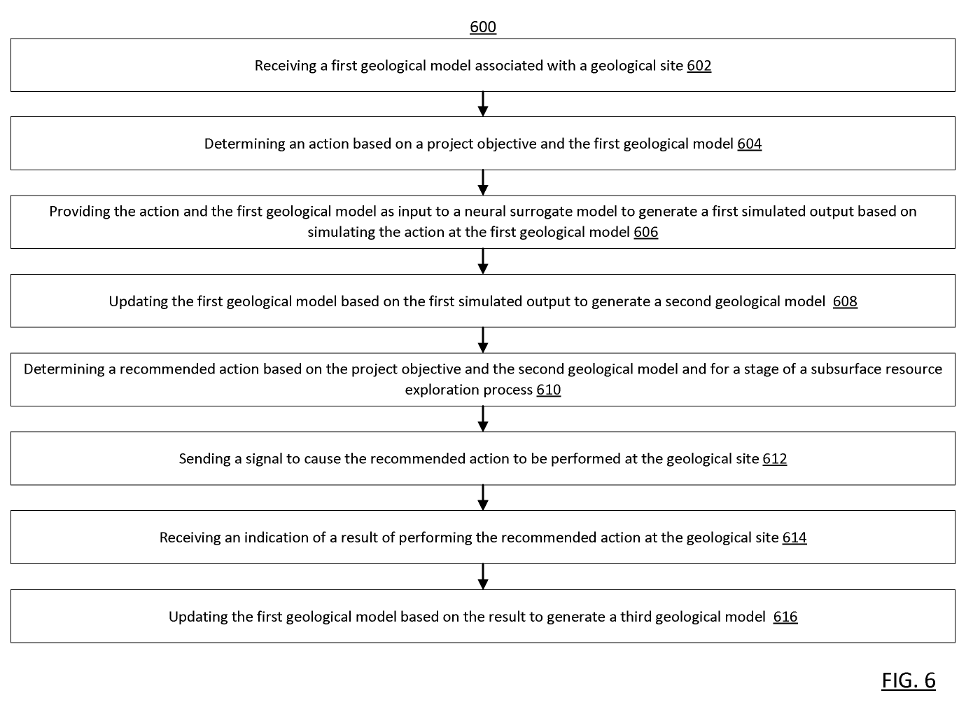

FIG. 6 illustrates a flowchart of a method 600 to determine recommended actions for stages of a subsurface resource exploration process, according to an embodiment. In some implementations, method 600 includes code stored in a memory (e.g., memory 104 of FIG. 1A) and executed and/or performed by a processor (e.g., processor 102 of FIG. 1A).

At 602, a first geological model (e.g., included in geological models 106) associated with a geological site is received.

At 604, an action (e.g., included in potential actions 110) is determined based on a project objective and the first geological model. In some implementations, determining the action includes determining the action based on the project objective and the first geological model being input to a reinforcement learning model.

At 606, the action and the first geological model are provided as input to a neural surrogate model to generate a first simulated output based on simulating the action and the first geological model. is simulated using the first geological model to generate a first simulated output.

At 608, the first geological model is updated based on the first simulated output to generate a second geological model (e.g., included in geological models 106).

At 610, a recommended action (e.g., included in recommended actions 112) is determined based on the project objective and the second geological model, where the second recommended action is for a second stage of the subsurface resource exploration process. In some implementations, 610 occurs automatically (e.g., without human intervention) in response to completing 608.

At 612, a signal is sent to cause the recommended action to be performed at the geological site. In some implementations, the recommended action can be automatically performed by a device (e.g., excavator, imaging device, sample collector, sample analyzer, etc.) at the geological site in response to the signal without human intervention. In some implementations, the recommended action can be a signal to instruct a human to perform the recommended action at the geological site.

At 614, an indication of a result of performing the recommended action at the geological site is received. In some implementations, the indication of the result is received in response to at least one sensor (e.g., sensors 120) at the geological site monitoring the geological site in response to the recommended action being taken. In some implementations, the indication is automatically sent from the sensor without human intervention. In some implementations, a user observes the geological site after the recommended action is taken and provides the indication of the result based on the observations.

At 616, the first geological model is updated based on the result to generate a third geological model. While not shown in FIG. 6, in some implementations, the method 600 can repeat with the third geological model to determine a second recommended action.

In some aspects, the embodiments described herein relate to a method, including: receiving a first geological model associated with a geological site; determining a first recommended action, the first recommended action being for a first stage of a subsurface resource exploration process, the determining the first recommended action including: determining a first action based on a project objective and the first geological model, simulating the first action using the first geological model to generate a first simulated output, updating the first geological model based on the first simulated output to generate a second geological model, determining a second action based on the project objective and the second geological model, simulating the second action using the second geological model to generate a second simulated output, updating the second geological model based on the second simulated output to generate a third geological model, and determining the first recommended action based on the project objective and the third geological model; receiving an indication representing a first result resulting from taking the first recommended action at the geological site; updating the first geological model based on the first result to generate a fourth geological model; and determining a second recommended action based on the project objective and the fourth geological model, the second recommended action being for a second stage of the subsurface resource exploration process.

In some aspects, the embodiments described herein relate to a method, wherein the determining the second recommended action includes: determining a third action based on the project objective and the fourth geological model; simulating the third action using the fourth geological model to generate a third simulated output; updating the fourth geological model based on the third simulated output to generate a fifth geological model; determining a fourth action based on the project objective and the fifth geological model; simulating the fourth action using the fifth geological model to generate a fourth simulated output; updating the fifth geological model based on the fourth simulated output to generate a sixth geological model; and determining the second recommended action based on the project objective and the sixth geological model.

In some aspects, the embodiments described herein relate to a method, further including: receiving an indication representing a second result, the second result resulting from taking the second recommended action at the geological site; updating the fourth geological model based on the second result to generate a fifth geological model; and determining a third recommended action for a third stage of the subsurface resource exploration process based on the project objective and the fifth geological model.

In some aspects, the embodiments described herein relate to a method, wherein the first geological model is a first probabilistic geological model, the second geological model is a second probabilistic geological model, the third geological model is a third probabilistic geological model, and the fourth geological model is a fourth probabilistic geological model. In some aspects, the embodiments described herein relate to a method, wherein: simulating the first action using the first geological model to generate the first simulated output further includes simulating the first action using a neural surrogate model and the first geological model to generate the first simulated output; and simulating the second action using the second geological model to generate the second simulated output further includes simulating the second action using the neural surrogate model and the second geological model to generate the second simulated output.

In some aspects, the embodiments described herein relate to a method, further including: sending, in response to determining the first recommended action, a signal to cause a device at the geological site to perform the first recommended action, the receiving the indication representing the first result being in response to at least one sensor at the geological site monitoring the geological site.

In some aspects, the embodiments described herein relate to a method, wherein the determining the first action includes determining the first action based on the project objective and the first geological model being input to a reinforcement learning model.

In some aspects, the embodiments described herein relate to a non-transitory processor- readable medium including instructions that, when executed by one or more processors, cause the one or more processors to: receive a first geological model associated with a geological site; determine an action based on a project objective and the first geological model; provide the action and the first geological model as input to a neural surrogate model to generate a first simulated output based on simulating the action at the first geological model; update the first geological model based on the first simulated output to generate a second geological model; determine a recommended action based on the project objective and the second geological model and for a stage of a subsurface resource exploration process; send a signal to cause the recommended action to be performed at the geological site; receive an indication of a result of performing the recommended action at the geological site; and update the first geological model based on the result to generate a third geological model.

In some aspects, the embodiments described herein relate to a non-transitory processor- readable medium, wherein the recommended action is a first recommended action and the stage is a first stage of the subsurface resource exploration process, the non-transitory processor-readable medium further including instructions that, when executed by the one or more processors, cause the one or more processors to: determine a second recommended action based on the project objective and the third geological model, the second recommended action being for a second stage of the subsurface resource exploration process.

In some aspects, the embodiments described herein relate to a non-transitory processor- readable medium, wherein the receiving the indication of the result is in response to at least one sensor at the geological site monitoring the geological site in response to the recommended action being performed.

In some aspects, the embodiments described herein relate to a non-transitory processor- readable medium, wherein the first geological model is a first probabilistic geological model, the second geological model is a second probabilistic geological model, and the third geological model is a third probabilistic geological model.

In some aspects, the embodiments described herein relate to a non-transitory processor- readable medium, wherein the sending the signal to cause the recommended action to be performed includes sending the signal to a device at the geological site to perform the recommended action. In some aspects, the embodiments described herein relate to a non-transitory processor- readable medium, wherein the determining the action includes determining the action based on the project objective and the first geological model being input to a reinforcement learning model.

In some aspects, the embodiments described herein relate to an apparatus, including: a memory; and a processor operatively coupled to the memory, the processor configured to: receive an input geological model associated with a geological site; iteratively perform, until an output geological model meets a predetermined criterion: determining a first action based on a project objective and the input geological model, simulating the first action using the input geological model to generate a first simulated output, updating the input geological model based on the first simulated output to generate the output geological model, and updating the input geological model to correspond to the output geological model when the predetermined criterion is met; determine a recommended action based on the project objective and the output geological model and for a stage of a subsurface resource exploration process; send a signal to cause the recommended action to be performed at the geological site; receive an indication representing a result resulting from taking the recommended action at the geological site; and update the output geological model based on the result to generate an updated geological model.

In some aspects, the embodiments described herein relate to an apparatus, wherein the recommended action is a first recommended action and the stage of the subsurface resource exploration process is a first stage of the subsurface resource exploration process, the processor is configured to determine a second recommended action based on the project objective and the updated geological model, the second recommended action being for a second stage of the subsurface resource exploration process.

In some aspects, the embodiments described herein relate to an apparatus, wherein the processor is configured to receive the indication representing the result in response to at least one sensor at the geological site monitoring the geological site in response to the recommended action being performed.

In some aspects, the embodiments described herein relate to an apparatus, wherein the processor is configured to send the signal to cause a device at the geological site to perform the recommended action.

In some aspects, the embodiments described herein relate to an apparatus, wherein the predetermined criterion includes at least one of a threshold number of iterations, a threshold amount of time spent iterating, or the output geological model having a predetermined characteristic.

In some aspects, the embodiments described herein relate to an apparatus, wherein the input geological model is a first probabilistic geological model and the output geological model is a second probabilistic geological model.

In some aspects, the embodiments described herein relate to an apparatus, wherein the processor is configured to determine the first action based on the project objective and the input geological model being input to a reinforcement learning model.

It should be understood that the disclosed embodiments are not intended to be exhaustive, and functional, logical, operational, organizational, structural and/or topological modifications may be made without departing from the scope of the disclosure. As such, all examples and/or embodiments are deemed to be non-limiting throughout this disclosure.

All definitions, as defined and used herein, should be understood to control over dictionary definitions, definitions in documents incorporated by reference, and/or ordinary meanings of the defined terms.

Examples of computer code include, but are not limited to, micro-code or micro- instructions, machine instructions, such as produced by a compiler, code used to produce a web service, and files containing higher-level instructions that are executed by a computer using an interpreter. For example, embodiments can be implemented using Python, Java, JavaScript, C--, and/or other programming languages and development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase "and/or," as used herein in the specification and in the embodiments, should be understood to mean "either or both" of the elements so conjoined, i.e., elements that are conjunctively present in some cases and disjunctively present in other cases. Multiple elements listed with "and/or" should be construed in the same fashion, i.e., "one or more" of the elements so conjoined. Other elements can optionally be present other than the elements specifically identified by the "and/or" clause, whether related or unrelated to those elements specifically identified. Thus, as a non-limiting example, a reference to "A and/or B", when used in conjunction with open-ended language such as "comprising" can refer, in one embodiment, to A only (optionally including elements other than B); in another embodiment, to B only (optionally including elements other than A); in yet another embodiment, to both A and B (optionally including other elements); etc.

As used herein in the specification and in the embodiments, "or" should be understood to have the same meaning as "and/or" as defined above. For example, when separating items in a list, "or" or "and/or" shall be interpreted as being inclusive, i.e., the inclusion of at least one, but also including more than one, of a number or list of elements, and, optionally, additional unlisted items. Only terms clearly indicated to the contrary, such as "only one of' or "exactly one of," or, when used in the embodiments, "consisting of," will refer to the inclusion of exactly one element of a number or list of elements. In general, the term "or" as used herein shall only be interpreted as indicating exclusive alternatives (i.e., "one or the other but not both") when preceded by terms of exclusivity, such as "either," "one of," "only one of," or "exactly one of." "Consisting essentially of," when used in the embodiments, shall have its ordinary meaning as used in the field of patent law.

As used herein in the specification and in the embodiments, the phrase "at least one," in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase "at least one" refers, whether related or unrelated to those elements specifically identified. Thus, as a non-limiting example, "at least one of A and B" (or, equivalently, "at least one of A or B," or, equivalently "at least one of A and/or B") can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as "comprising," "including," "carrying," "having," "containing," "involving," "holding," "composed of," and the like are to be understood to be open-ended, i.e., to mean including but not limited to. Only the transitional phrases "consisting of' and "consisting essentially of' shall be closed or semi-closed transitional phrases, respectively, as set forth in the United States Patent Office Manual of Patent Examining Procedures, Section 2111.03.

Some embodiments described herein relate to a computer storage product with a non- transitory computer-readable medium (also can be referred to as a non-transitory processor- readable medium) having instructions or computer code thereon for performing various computer- implemented operations. The computer-readable medium (or processor-readable medium) is non- transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer- readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read- Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, JavaTM, Ruby, Visual BasicTM, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. A method, comprising:
receiving a first geological model associated with a geological site;
determining a first recommended action, the first recommended action being for a first stage of a subsurface resource exploration process, the determining the first recommended action including:
determining a first action based on a project objective and the first geological model,
simulating the first action using the first geological model to generate a first simulated output,
updating the first geological model based on the first simulated output to generate a second geological model,
determining a second action based on the project objective and the second geological model,
simulating the second action using the second geological model to generate a second simulated output,
updating the second geological model based on the second simulated output to generate a third geological model, and
determining the first recommended action based on the project objective and the third geological model;
receiving an indication representing a first result resulting from taking the first recommended action at the geological site;
updating the first geological model based on the first result to generate a fourth geological model; and
determining a second recommended action based on the project objective and the fourth geological model, the second recommended action being for a second stage of the subsurface resource exploration process.

2. The method of claim 1, wherein the determining the second recommended action includes:
determining a third action based on the project objective and the fourth geological model;
simulating the third action using the fourth geological model to generate a third simulated output;
updating the fourth geological model based on the third simulated output to generate a fifth geological model;
determining a fourth action based on the project objective and the fifth geological model;
simulating the fourth action using the fifth geological model to generate a fourth simulated output;
updating the fifth geological model based on the fourth simulated output to generate a sixth geological model; and
determining the second recommended action based on the project objective and the sixth geological model.

3. The method of claim 1, further comprising:
receiving an indication representing a second result, the second result resulting from taking the second recommended action at the geological site;
updating the fourth geological model based on the second result to generate a fifth geological model; and
determining a third recommended action for a third stage of the subsurface resource exploration process based on the project objective and the fifth geological model.

4. The method of claim 1, wherein the first geological model is a first probabilistic geological model, the second geological model is a second probabilistic geological model, the third geological model is a third probabilistic geological model, and the fourth geological model is a fourth probabilistic geological model.

5. The method of claim 1, wherein:
simulating the first action using the first geological model to generate the first simulated output further includes simulating the first action using a neural surrogate model and the first geological model to generate the first simulated output; and
simulating the second action using the second geological model to generate the second simulated output further includes simulating the second action using the neural surrogate model and the second geological model to generate the second simulated output.

6. The method of claim 1, further comprising:
sending, in response to determining the first recommended action, a signal to cause a device at the geological site to perform the first recommended action, the receiving the indication representing the first result being in response to at least one sensor at the geological site monitoring the geological site.

7. The method of claim 1, wherein the determining the first action includes determining the first action based on the project objective and the first geological model being input to a reinforcement learning model.

8. A non-transitory processor-readable medium comprising instructions that, when executed by one or more processors, cause the one or more processors to:
receive a first geological model associated with a geological site;
determine an action based on a project objective and the first geological model;
provide the action and the first geological model as input to a neural surrogate model to generate a first simulated output based on simulating the action at the first geological model;
update the first geological model based on the first simulated output to generate a second geological model;
determine a recommended action based on the project objective and the second geological model and for a stage of a subsurface resource exploration process;
send a signal to cause the recommended action to be performed at the geological site;
receive an indication of a result of performing the recommended action at the geological site; and
update the first geological model based on the result to generate a third geological model.

9. The non-transitory processor-readable medium of claim 8, wherein the recommended action is a first recommended action and the stage is a first stage of the subsurface resource exploration process, the non-transitory processor-readable medium further comprising instructions that, when executed by the one or more processors, cause the one or more processors to:
determine a second recommended action based on the project objective and the third geological model, the second recommended action being for a second stage of the subsurface resource exploration process.

10. The non-transitory processor-readable medium of claim 8, wherein the receiving the indication of the result is in response to at least one sensor at the geological site monitoring the geological site in response to the recommended action being performed.

11. The non-transitory processor-readable medium of claim 8, wherein the first geological model is a first probabilistic geological model, the second geological model is a second probabilistic geological model, and the third geological model is a third probabilistic geological model.

12. The non-transitory processor-readable medium of claim 8, wherein the sending the signal to cause the recommended action to be performed includes sending the signal to a device at the geological site to perform the recommended action.

13. The non-transitory processor-readable medium of claim 8, wherein the determining the action includes determining the action based on the project objective and the first geological model being input to a reinforcement learning model.

14. An apparatus, comprising:
a memory; and
a processor operatively coupled to the memory, the processor configured to:
receive an input geological model associated with a geological site;
iteratively perform, until an output geological model meets a predetermined criterion:
determining a first action based on a project objective and the input geological model,
simulating the first action using the input geological model to generate a first simulated output,
updating the input geological model based on the first simulated output to generate the output geological model, and
updating the input geological model to correspond to the output geological model when the predetermined criterion is met;
determine a recommended action based on the project objective and the output geological model and for a stage of a subsurface resource exploration process;
send a signal to cause the recommended action to be performed at the geological site;
receive an indication representing a result resulting from taking the recommended action at the geological site; and
update the output geological model based on the result to generate an updated geological model.

15. The apparatus of claim 14, wherein the recommended action is a first recommended action and the stage of the subsurface resource exploration process is a first stage of the subsurface resource exploration process, the processor is configured to determine a second recommended action based on the project objective and the updated geological model, the second recommended action being for a second stage of the subsurface resource exploration process.

16. The apparatus of claim 14, wherein the processor is configured to receive the indication representing the result in response to at least one sensor at the geological site monitoring the geological site in response to the recommended action being performed.

17. The apparatus of claim 14, wherein the processor is configured to send the signal to cause a device at the geological site to perform the recommended action.

18. The apparatus of claim 14, wherein the predetermined criterion includes at least one of a threshold number of iterations, a threshold amount of time spent iterating, or the output geological model having a predetermined characteristic.

19. The apparatus of claim 14, wherein the input geological model is a first probabilistic geological model and the output geological model is a second probabilistic geological model.

20. The apparatus of claim 14, wherein the processor is configured to determine the first action based on the project objective and the input geological model being input to a reinforcement learning model.
